(19) United States
(12) Patent Application Publication
(10) Pub. No.: US 2020/0383315 A1
(43) Pub. Date: Dec. 10, 2020

(54) TREESTAND WITH REMOTELY ACTUATED JAWS

(71) Applicant: Anthony D. Overbaugh, Winchester, VA (US)

(72) Inventor: Anthony D. Overbaugh, Winchester, VA (US)

(21) Appl. No.: 16/806,579

(22) Filed: Mar. 2, 2020

Related U.S. Application Data
(60) Provisional application No. 62/857,168, filed on Jun. 4, 2019.

(51) Int. Cl. A01M 31/02

(52) U.S. Cl. CPC A01M 31/02

(57) ABSTRACT

A treestand having a ladder and platform at the top of the ladder is provided with gripping jaws under the platform. The pair of jaws are connected to one another by a first strap. A second strap connected to the first strap at a point between the pair of jaws. The second strap passed through at least one guide and extends downward to be accessible to a person at ground level. When the second strap is pulled downward, the first strap moves toward a rear edge of the platform, causing the jaws to pivot from a first open position to a second closed position.

### Cross Reference to Related Applications

This application claims benefit under 35 USC 119 (e) to provisional application 62/857,168, filed Jun. 4, 2019, the entire content of which are incorporated herein by reference.

### BACKGROUND OF THE INVENTION

Treestands are often used in hunting, particularly bow hunting. Typically, the treestand has a ladder extending upward to a platform that is secured to the tree. The elevated position of the platform allows errant shots to quickly hit the ground without travelling far, increasing safety. The platform must be comfortable and securely attached to a tree to enable a person to remain on the platform for an extended period of time, often including movement by the person.

It is an object of the invention to provide a treestand that can be secured at an elevated point of a tree by a person on the ground.

It is another object of the invention to provide a treestand that securely attaches to a tree.

It is yet another object of the invention to provide a treestand that is portable and easy to assemble.

It is still another object of the invention to provide a treestand having jaws that can be closed by a person on ground level.

These and other objects of the invention will be apparent to one of ordinary skill in the art after reading the disclosure of the invention.

### SUMMARY OF THE INVENTION

A treestand having a ladder and platform at the top of the ladder is provided with gripping jaws under the platform. The pair of jaws are connected to one another by a first strap. A second strap connected to the first strap at a point between the pair of jaws. The second strap passed through at least one guide and extends downward to be accessible to a person at ground level. When the second strap is pulled downward, the first strap moves toward a rear edge of the platform, causing the jaws to pivot from a first open position to a second closed position. The jaws are biased to the first position and securing the second strap, such as to the ladder, maintains the jaws in the second position.

### BRIEF DESCRIPTION OF THE DRAWINGS

FIG. 1 is a perspective view of the treestand attached to a tree;

FIG. 2 is a bottom view of the platform having the remotely actuated jaws; and

FIG. 3 is a schematic view of the jaws and strap.

### DETAILED DESCRIPTION OF THE INVENTION

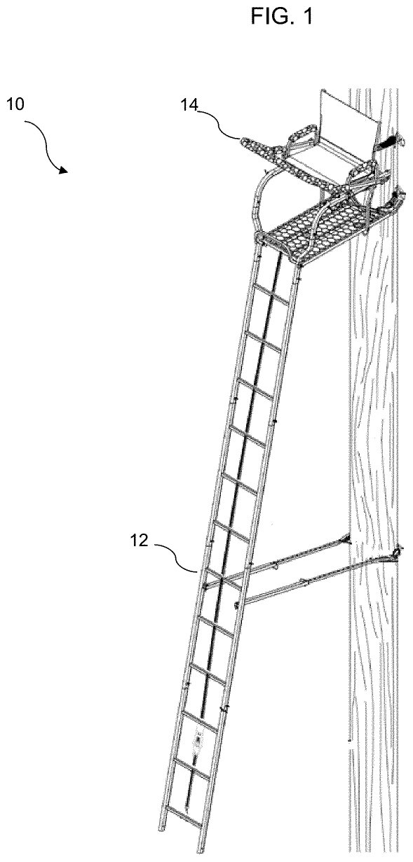

A seen in FIG. 1, the treestand attaches to a tree with a ladder 12 extending upward to a platform 14 that supports the user. The jaws 20 are under the platform and are movable between an open position and a closed position. The jaws are biased to an open position by any suitable device, such as a coil spring or torsional spring, to keep the ends of the jaws separated from one another to allow a front edge of the platform to contact the tree. After the platform is secured against the tree at an appropriate and stable position, the jaws are closed. When closed, the jaws extend beyond the front edge of the platform to engage the tree at spaced locations.

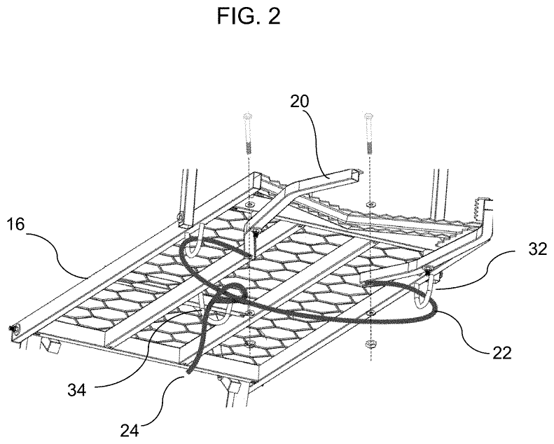

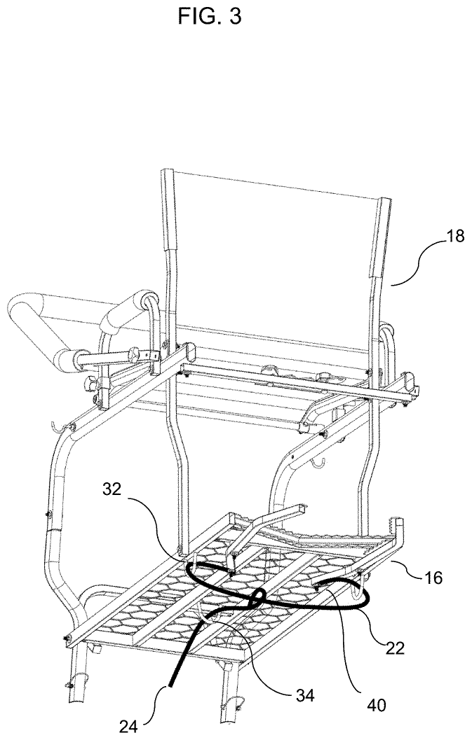

The jaws 20 are seen in FIG. 2. A first strap 22 extends between the straps and a second strap 24 connects to the first strap at a point between the two ends of the first strap. The second strap extends toward the rear edge of the platform and through a guide 34 on the platform, allowing the strap to change direction and extend toward the ground. Therefore, downward force and movement on the second strap 24 is translated to movement of the first strap 22 toward the rear edge of the platform. This causes the jaws to pivot toward the closed position, as will be described in more detail with reference to FIG. 3. The user is able to close the jaws to secure the platform to the tree from the ground, before climbing up the ladder. This guide could also be on the ladder. A ratchet strap may be used to further secure the platform to the tree.

The jaws each have a pivot point 25 connecting the jaw to the platform. The jaws each have a gripping portion extending forward from the pivot point and a lever portion extending rearwardly and on an opposite sides of the pivot point from the gripping portion. The gripping portion has a curved shape to increase the contact surface with a tree and a lever portion and may include a serrated edge to improve gripping to a tree. The open position of the jaws creates a space between the first end of the jaws that is greater than a diameter of a tree to be used as a support. If the diameter of the tree is too larger, the jaws will not be able to close to provide enough stability to the treestand.

The first strap connects to an end of each jaw and extends outward to second guides 32. As seen in FIG. 3, when the second strap is pulled rearwardly by a person on the ground, the first strap is pulled though the second guides 32, moving the second end of the jaws apart, pivoting the jaws so that the first end of the jaws move closer to one another and around the tree. As seen in FIG. 3, a first pair of guides 32, such as eyebolts, are arranged laterally outwardly from the connection points 40 of the first strap to the pair of jaws. Preferable, the pair of guides 32 and connection points 40 lie along a straight line. The first pair of guides 32 allow the first strap 22 to make a change in direction so that when the first strap is pulled in a first direction toward a rear of the platform, the first straps pull the connection points, and therefore the ends of the jaws, in opposite direction in a second direction, thereby pivoting the jaws to a second closed position. The second strap 34 can them be secured to a stationary object, such as the ladder, to maintain the jaws in the closed position.

I claim:

1. A treestand, comprising:
a ladder having a plurality of rungs;
a platform extending outwardly in a first direction from an upper end of the ladder;
a gripping surface at a front edge of the platform;
a pair of rotatable jaws under the platform, the pair of jaws rotatable between a first open position and a second closed position;
a first strap having a pair of ends, each end connected to one of the pair of rotatable jaws at a connection point; and
a second strap connected to the first strap at a point between the ends of the first strap.

2. The treestand of claim 1, wherein the pair of jaws is biased to the first open position.

3. The treestand of claim 1, further comprising a pair of guides spaced laterally of the connection points, the first strap extending through the pair of guides.

4. The treestand of claim 3, further comprising a second guide on the platform, the second strap extending through the second guide.

5. The treestand of claim 3, further comprising a second guide on the ladder, the second strap extending through the second guide.

6. The treestand of claim 1, further comprising a second guide on the platform, the second strap extending through the second guide.

7. The treestand of claim 1, further comprising a second guide on the ladder, the second strap extending through the second guide.
